(19) United States
(12) Patent Application Publication
(10) Pub. No.: US 2011/0184785 A1
(43) Pub. Date: Jul. 28, 2011

(54) Methodology for Monitoring and Tracking Process Changes, Special Cause Occurrences, Process Improvement Actions, and Their Effects, in Single or Multiple, Correlated Processes

(76) Inventors: Ileana Roman Stoica, Hanover, MN (US); Sorin Roman Stoica, Hanover, MN (US)

(21) Appl. No.: 12/692,634

(22) Filed: Jan. 24, 2010

(51) Int. Cl. G06Q 10/00

(52) U.S. Cl. 705/7.39; 705/301

(57) ABSTRACT

A methodology for monitoring and tracking of process changes, special cause occurrences, and process improvement actions, and their effects on correlated processes, which includes the following steps: identifying the targeted process(es), defining the key performance indicator(s) (KPIs) for the process(es), selecting the appropriate frequency of the data points (i.e. daily, weekly, monthly, etc), capturing and reflecting the data points every completed period on a tracking chart or similar visual aid, and document significant events, special cause occurrences, and process improvement action start dates in a visually correlated matrix or data table, with data point dates serving as alignment indices.

### BACKGROUND OF THE INVENTION

In most process improvement work we encounter quite often situations in which a process improvement initiative is implemented and, consequently, the targeted process output will show, more or less, the desired result, while, in other processes, it can have an adverse effect that could go unnoticed or undiagnosed. Weeks or months after the fact, while trying to fix the negatively-impacted correlated process in a different area, it is very difficult—practice has demonstrated—to recall, reference, or to be able to re-assess the effects of all forgotten changes that have happened. Process improvement and process (re-)engineering change agents and champions can manifest this type of tunnel-vision, without fault, when focusing on improving specific, targeted processes.

The more complex the process environment, the higher the likelihood of the above-described unwanted effects to happen. Processes are correlated in many ways, some more visible and logical, some less, with higher risks of not being considered for potential impacts from process changes.

Some organizations are change intensive, whether because of their nature, goals, or if undergoing a transformation. In change intensive environments this type of issue is very likely to occur.

Regardless of the root cause, it is quite challenging to pinpoint which process change, aimed at process A, that has been implemented in the past, has resulted in an unwanted change in process B, that we have noticed for some time, and could not find any cause for. There is also a time waste component to this challenge.

### SUMMARY OF THE INVENTION

This methodology allows the documenting and tracking of key processes, and all changes that happen around them: special cause occurrences, process (re-)engineering, process improvement initiatives, etc. Somewhat like a navigation log for businesses, this methodology allows clear visibility into process change results, clean of all special cause occurrence effects, and gives the hindsight its full 20/20 abilities, by making possible the quick, unequivocal identification of the change responsible for unwanted effects.

This methodology for monitoring and tracking of process changes, special cause occurrences, and process improvement actions, and their effects on correlated processes, includes the following steps:
Step 1: identification of the targeted process(es) (i.e. order fulfillment, sales efficiency, and customer satisfaction score);
Step 2: definition of the key performance indicator(s) (KPIs) for these process(es) (i.e. service level for fulfillment, conversion rate, and customer satisfaction);
Step 3: selection of the appropriate frequency of the data points (i.e. daily, weekly, monthly, etc) (i.e. weekly);
Step 4: capture and illustration of the data points every completed period on a tracking chart or similar visual aid;
Step 5: documentation of significant events, special cause occurrences, and process improvement action start dates in a visually correlated matrix, with data point dates serving as alignment indices.

Let's explore the methodology by means of an example. We will start tracking the key metrics, projects, and events for an operational environment, in sync with key customer deliverable metrics and customer satisfaction. Over a period of 14 weeks, numbered 1 through 14, we will consider four special cause events with potential impact on one or more key metrics, and three process improvement actions, also with their potential impact on the selected KPIs. These are:
Special cause incidents or events:
   Distribution center fire—week 7
   Distribution center reopens after renovation—week 11
   A TV show features our product during prime time—week 13
   Nationwide syndication of the above TV show—week 14
Projects or actions:
   Online Sales Process Improvement, implemented in week 3
   TV Ad Campaign Span, running weeks 1 through 8
   Customer centric warranty policy revision, implemented in week 5

We are following the methodology steps described above:
Step 1: identification of the targeted processes. These are: order fulfillment, sales efficiency, and customer satisfaction.
Step 2: definition of the key performance indicators for these processes:
   service level as KPI for order fulfillment—defined as percentage of orders shipped under 24 hours;
   sales lead conversion rate as KPI for sales efficiency, defined as percentage of leads converted into final sales;
   customer satisfaction score, as KPI for customer satisfaction, defined as the percentage of customers who indicate their level of satisfaction with our service as being “satisfied” or “very satisfied”—a global measure of our entire service process.
Step 3: selection of the appropriate frequency of the data points. The data points will be collected weekly.
Step 4+5: capture and illustration of the data points every completed period on a tracking chart or similar visual aid, and documentation of significant events, special cause occurrences, and process improvement action: via attached charts referenced below.

We will begin by adding one metric-service level in delivery, for example. FIG. 1 shows service level in fulfillment, correlated with the special cause occurrences, process improvement actions, and other events.

As it becomes immediately visible, in week 7 service level in delivery had a lot to suffer from a special cause event—the distribution center fire. SL in delivery recovered almost completely in week 11—when the DC reopened. This special cause and its effect are obvious and easy to catch.

Not so easy to catch is a trend impacted by a process improvement implementation. Weeks 3 to 6 we are able to see that the online sales process improvement had no adverse impact on service level in delivery—quite the opposite. After the DC fire though, the positive effect of this online process improvement is “covered” by this special cause event and its effect. We are also noticing that the TV Show featuring the product on Channel 5 during prime time has no impact on delivery; nor does the syndication of the same show. It shouldn't have.

FIG. 2 shows the same approach in monitoring and tracking of the second process KPI—lead conversion rate.

In weeks 3 through 8, we are able to notice the positive effect of the online sales process improvement. The delta between the initial value (˜26%), and the weeks 4-8 average rate (˜49%), shows the net benefit of the online sales process improvement, because the rate of 26% we had prior to week 4 was a rate achieved while the TV ad campaign was running. The positive effect of the online sales process improvement is most likely continuing past week 8, but it is hidden by the negative impact of the suspended TV ad campaign. Once the TV show and the national syndication happen in weeks 13 and 14, we see the conversion rate hit unprecedented high values. The distribution center fire and, respectively, reopen, have no visible effect on conversion rates—which makes sense.

Customer satisfaction score is next, charted in FIG. 3.

Charting customer satisfaction score will show the positive effect of the online sales process improvement starting to show on week 3 followed closely by yet another positive effect showing from the warranty policy revision. This score is definitely headed in the right direction. The TV show and its syndication in weeks 13 and 14 are reflecting a potential positive impact; to be sure we would need more data points to validate this growth is in direct correlation with these special cause events.

FIG. 4 shows all KPIs, on the changes & effects tracking chart, with all processes, synchronized.

Although it creates a busy look, and is not recommended to be loaded with more than 3-5 KPIs without analysis software support, the compounded view will allow a quick, rearview mirror look at the effect of special cause occurrences—marked with arrows. From the compounded view, we can work “backwards”: if we notice common points of inflexion in our charts, or if we want to examine one or more KPIs performance in conjunction with others, and we are noticing common trends, this compounded view allows for the investigation into root causes to happen without delay, error, omission, or hesitation.

Another way to use the methodology is to work “backwards” in diagnosing root cause for unexpected KPI performance, by isolating the anomalous trend from the rest of the KPIs and analyzing it versus documented special cause occurrences, events, process changes, and process improvement actions.

### BRIEF DESCRIPTION OF THE DRAWINGS

FIG. 1: Changes & effects tracking chart—multiple processes—service level in delivery

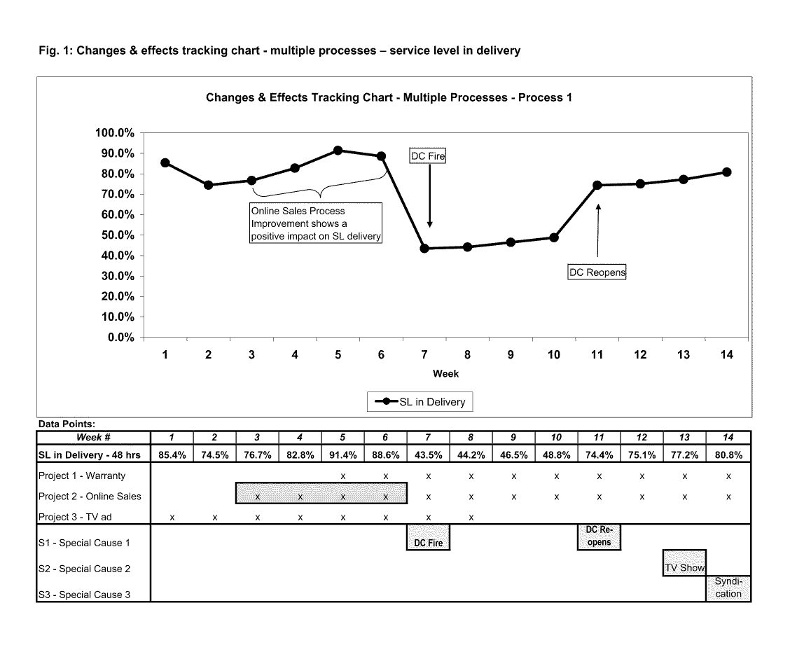

FIG. 2: Changes & effects tracking chart—multiple processes—lead conversion rate

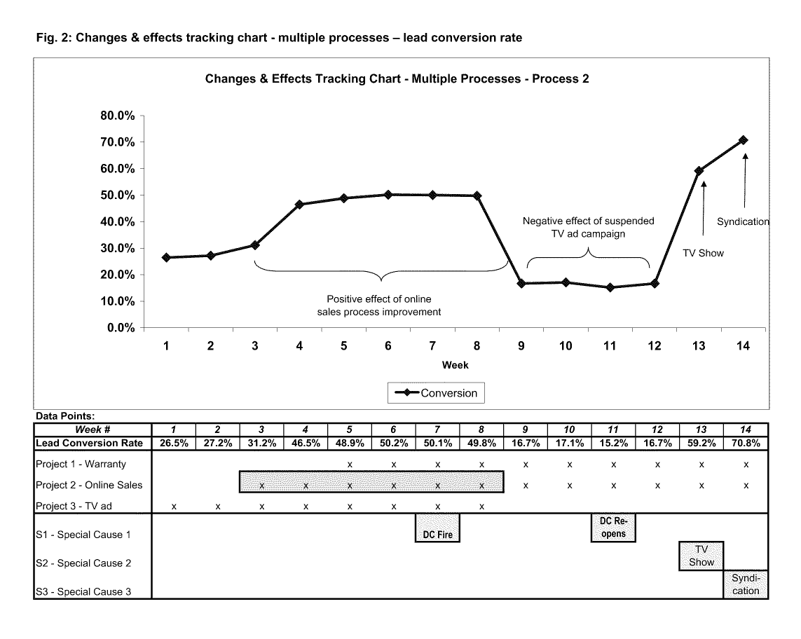

FIG. 3: Changes & effects tracking chart—multiple processes—customer satisfaction score

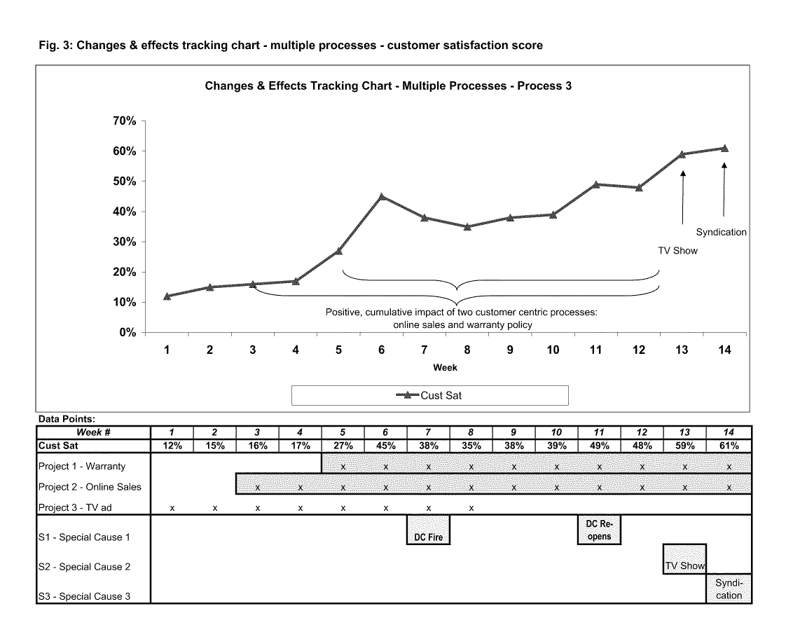

FIG. 4: Changes & effects tracking chart—multiple processes synchronized—all KPIs

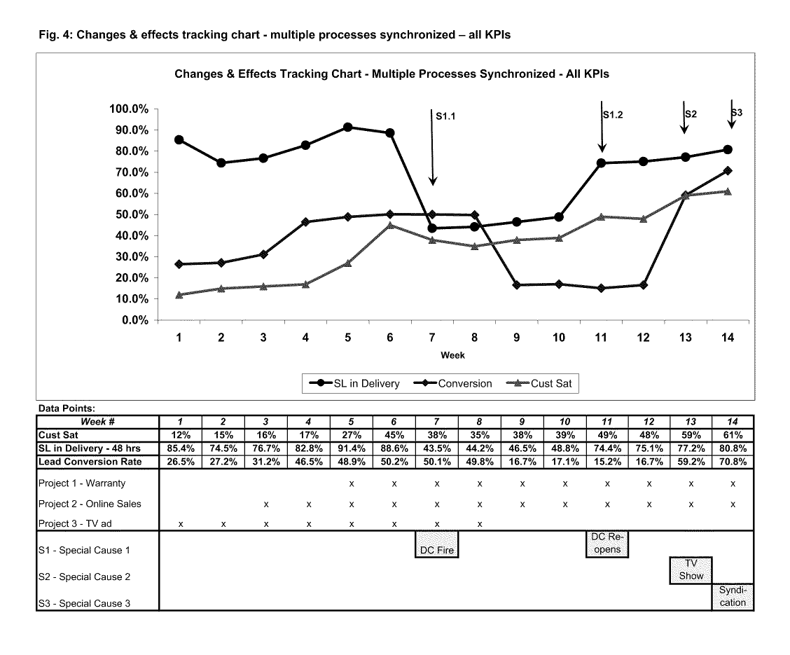

1. A methodology for monitoring and tracking of process changes, special cause occurrences, and process improvement actions, and their effects on correlated processes, which includes the following steps: identifying the targeted process(es) (i.e. order fulfillment, sales efficiency, and customer satisfaction score), defining the key performance indicator(s) (KPIs) for the process(es) (i.e. service level for fulfillment, conversion rate, and customer satisfaction score expressed in percentages), selecting the appropriate frequency of the data points (i.e. daily, weekly, monthly, etc) (i.e. weekly), capturing and reflecting the data points every completed period on a tracking chart or similar visual aid, and document significant events, special cause occurrences, and process improvement action start dates in a visually correlated matrix or data table, with data point dates serving as alignment indices.

2. The methodology of claim 1, wherein the targeted processes can be identified initially or subsequently (at a later date).

3. The methodology of claim 1, wherein the targeted processes can be finite or continuous.

4. The methodology of claim 1, wherein the targeted processes can be simple or complex.

5. The methodology of claim 1, wherein the targeted processes can be comprised of different other processes (i.e. order fulfillment is comprised of order picking, packing, and shipping).

6. The methodology of claim 1, wherein the targeted processes can be simultaneous or sequential.

7. The methodology of claim 1, wherein the targeted processes can be physical, data, or virtual processes (i.e. processes utilized in manufacturing, computing, and theoretical modeling, respectively).

8. The methodology of claim 1, wherein the targeted processes can have a baseline determination performed.

9. The methodology of claim 1, wherein the special cause occurrences can be acts of nature (i.e. tornado), or man-made events (i.e. demolition).

10. The methodology of claim 1, wherein the process improvement actions can be one time events (i.e. replaced a piece of equipment) or on-going process changes (i.e. limiting the shrink-wrapping process in the packaging process).

11. The methodology of claim 1, wherein the units to be selected out of a group of many similar units are phenomena or events.

12. A computerized system using an application for the implementation, documentation, and management of a methodology for monitoring and tracking of process changes, special cause occurrences, and process improvement actions, and their effects on correlated processes, which includes the following steps: identifying the targeted process(es) (i.e. order fulfillment, sales efficiency, and customer satisfaction score), defining the key performance indicator(s) (KPIs) for the process(es) (i.e. service level for fulfillment, conversion rate, and customer satisfaction score expressed in percentages), selecting the appropriate frequency of the data points (i.e. daily, weekly, monthly, etc) (i.e. weekly), capturing and reflecting the data points every completed period on a tracking chart or similar visual aid, and document significant events, special cause occurrences, and process improvement action start dates in a visually correlated matrix or data table, with data point dates serving as alignment indices.

13. The system of claim 12 further comprising one or more computers configured to aid a user to identify the effects of process changes, special cause occurrences, or process improvement actions.

14. The system of claim 12 further comprising human or automated event or occurrence registration.

15. The system of claim 12 further comprising computerized detection of trend changes, inflection points, and anomalies, on tracked data curves.

16. The system of claim 12 further comprising the functionality of management, tracking, documentation and archiving of the effects of process changes, special cause occurrences, or process improvement actions.

17. The system of claim 12 further comprising the functionality of process performance management (including compensation), based on performance indicators for said processes.

18. The system of claim 12 further comprising the functionality of identifying correlations between process changes, special cause occurrences, or process improvement actions, and process performance.
